(19) United States
(12) Patent Application Publication
(10) Pub. No.: US 2022/0394917 A1
(43) Pub. Date: Dec. 15, 2022

(54) Weed Trimmer Trolley Assembly

(71) Applicant: Damian Petersen, Andover, MN (US)

(72) Inventor: Damian Petersen, Andover, MN (US)

(21) Appl. No.: 17/344,853

(22) Filed: Jun. 10, 2021

(51) Int. Cl. A01D 34/416; B60B 33/00; B60B 33/04

(52) U.S. Cl. CPC A01D 34/416; B60B 33/0015; B60B 33/04

(57) ABSTRACT

A weed trimmer trolley assembly includes a clamp which has a first portion that is closable with a second portion for securing around a pole of a weed trimmer. A swivel is rotatably disposed on the clamp and the swivel is positionable at a variety of angles with respect to the weed trimmer. A pair of legs is each coupled to and extends downwardly from the swivel. Each of the legs comprises a first half that threadably engages a second half such that each of the legs has an adjustable length. A pair of arms is provided and each of the arms is coupled to a respective one of the legs. A pair of rollers is each rotatably coupled to a respective one of the arms to support the weed trimmer and thereby assist a physically limited user with employing the weed trimmer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trolley devices and more particularly pertains to a new trolley device for facilitating a weed trimmer to be rolled along a support surface. The device includes a swivel that is attachable to a pole of the weed trimmer, a pair of legs coupled to the swivel and a pair of rollers attached to the legs. Each of the rollers rolls along a support surface such that a user of the weed trimmer does not have to support the weight of the weed trimmer.

### (2) Description of Related Art Including Information Disclosed Under 37 CFR 1.97 and 1.98

The prior art relates to trolley devices including a variety of trolleys that are attachable to a pole of a weed trimmer for rolling, rather than carrying, the weed trimmer. The prior art discloses a variety of roller devices that each includes a plurality of legs, each being attachable to a pole of a weed trimmer, and which have wheels coupled thereto for rolling the weed trimmer. In no instance does the prior art disclose a trolley that includes a swivel and telescopically adjustable legs.

### BRIEF SUMMARY OF THE INVENTION

An embodiment of the disclosure meets the needs presented above by generally comprising a clamp which has a first portion that is closable with a second portion for securing around a pole of a weed trimmer. A swivel is rotatably disposed on the clamp and the swivel is positionable at a variety of angles with respect to the weed trimmer. A pair of legs is each coupled to and extends downwardly from the swivel. Each of the legs comprises a first half that threadably engages a second half such that each of the legs has an adjustable length. A pair of arms is provided and each of the arms is coupled to a respective one of the legs. A pair of rollers is each rotatably coupled to a respective one of the arms to support the weed trimmer and thereby assist a physically limited user with employing the weed trimmer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a weed trimmer trolley assembly according to an embodiment of the disclosure.

FIG. 2 is a left side view of an embodiment of the disclosure.

FIG. 3 is a front view of an embodiment of the disclosure.

FIG. 4 is a cross sectional view taken along line 4-4 of FIG. 2 of an embodiment of the disclosure.

FIG. 5 is a perspective view of an embodiment of the disclosure showing a ball being adjusted.

FIG. 6 is a perspective in-use view of an embodiment of the disclosure.

FIG. 7 is a perspective in-use view of an embodiment of the disclosure showing a curved pole on a weed trimmer.

### DETAILED DESCRIPTION OF THE INVENTION

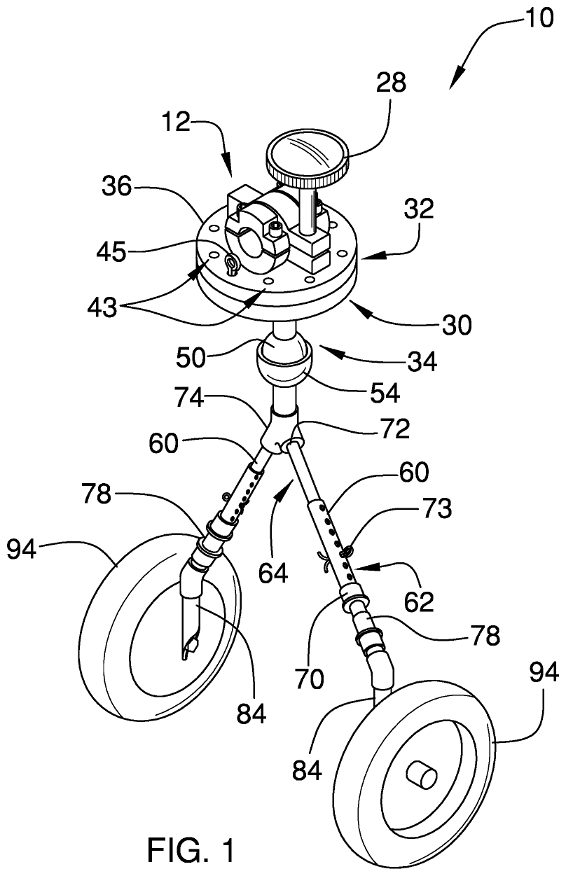

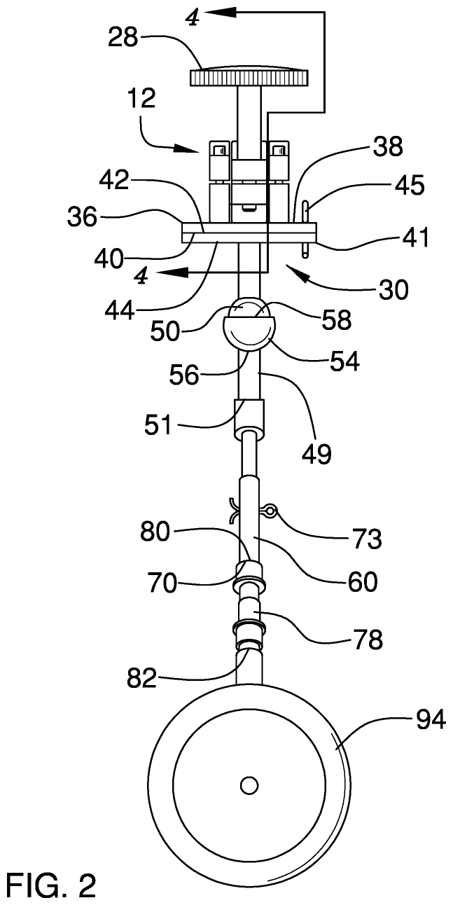

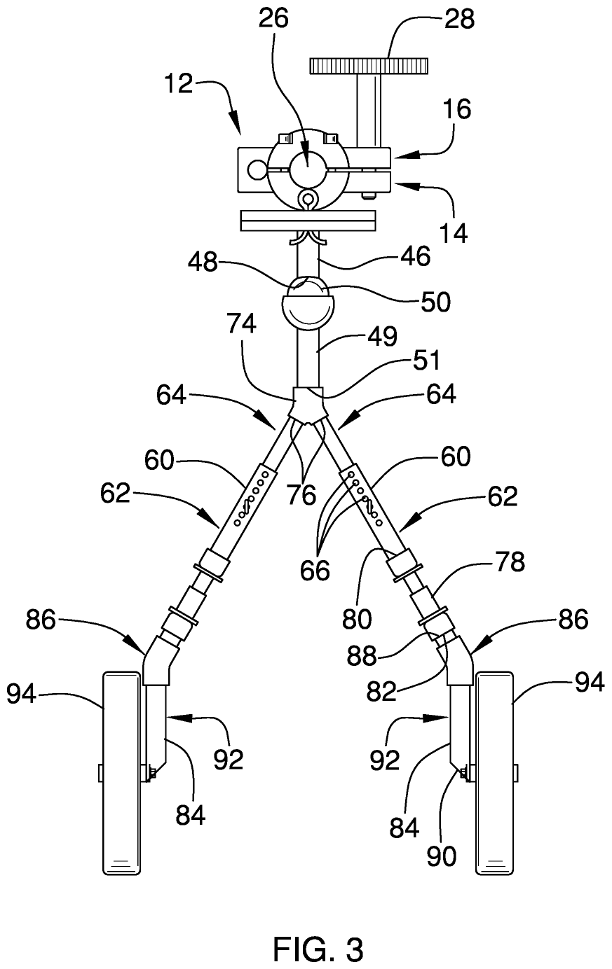

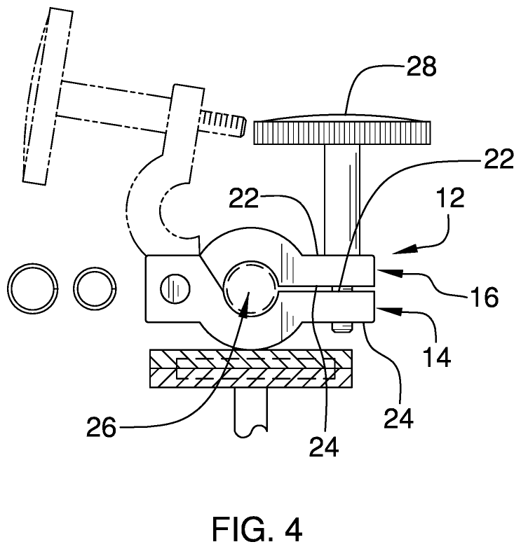

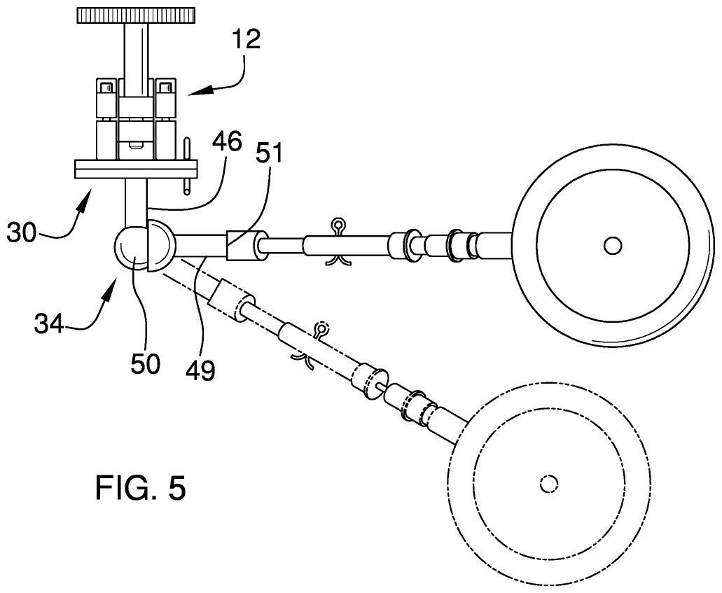

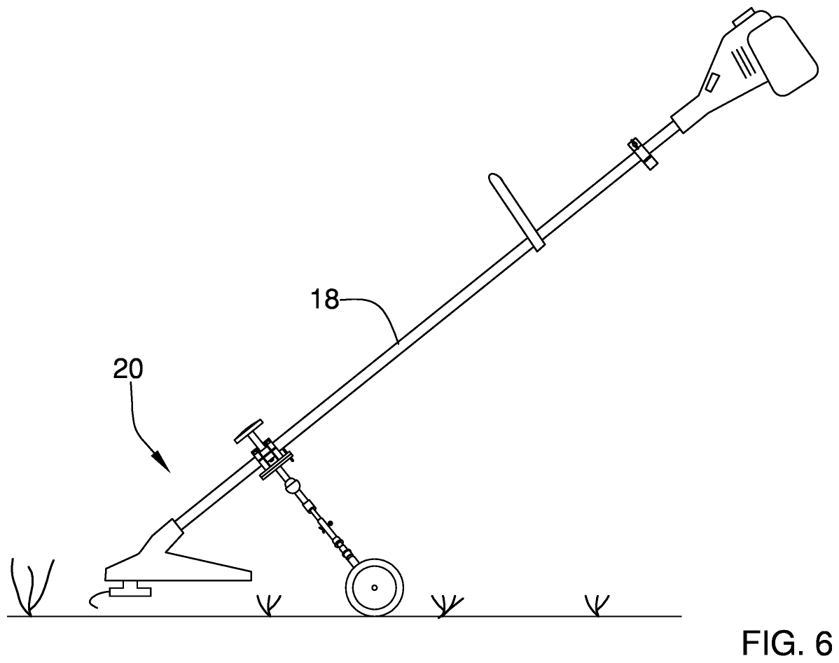

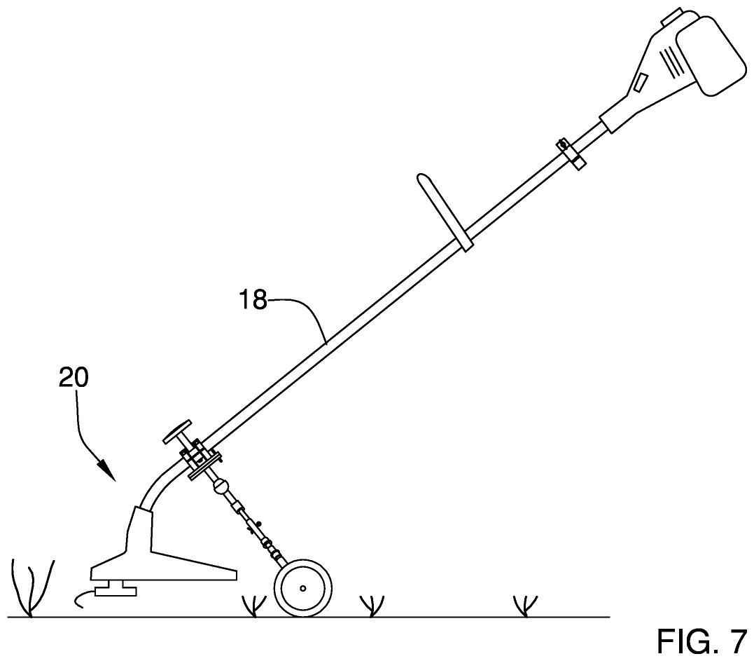

With reference now to the drawings, and in particular to FIGS. 1 through 7 thereof, a new trolley device embodying the principles and concepts of an embodiment of the disclosure and generally designated by the reference numeral 10 will be described.

As best illustrated in FIGS. 1 through 7, the weed trimmer trolley assembly 10 generally comprises a clamp 12 having a first portion 14 that is closable with a second portion 16 such that the clamp 12 can to be secured around a pole 18 of a weed trimmer 20. The weed trimmer 20 may be a gas powered weed trimmer, an electric weed trimmer or any other type of powered weed trimmer. Each of the first portion 14 and the second portion 16 has a top side 22 and a bottom side 24. The top side 22 of the first portion 14 is concavely arcuate with respect to the bottom side 24 of the first portion 14, and the bottom side 24 of the second portion 16 is concavely arcuate with respect to the top side 22 of the second portion 16. Moreover, the bottom side 24 of the second portion 16 is hingedly coupled to the top side 22 of the first portion 14.

The second portion 16 is positionable in a closed position having the bottom side 24 of the second portion 16 resting on the top side 22 of the first portion 14 to define a hole 26 to accommodate the pole 18 of the weed trimmer 20. The clamp 12 includes a screw 28 extending through the second portion 16 and releasably engaging the first portion 14 when the second portion 16 is in the closed position. The screw 28 tightens the second portion 16 against the first portion 14 when the screw 28 is tightened to compress the clamp 12 around the pole 18 of the weed trimmer 20. In this way the clamp 12 is secured to the pole 18 at a location that is preferred by a user of the weed trimmer 20. The user might be a physically limited user, such as a person suffering from a back injury, or other user that would find employing a weed trimmer 20 to be painful or difficult.

A swivel 30 is included that is rotatably disposed on the clamp 12. The swivel 30 includes a primary portion 32 that is rotatable about a first axis and a secondary portion 34 that is ballable about a perpendicular axis with respect to the first axis. In this way the swivel 30 is positionable at a variety of angles with respect to the weed trimmer 20. The primary portion 32 of the swivel 30 comprises a first disk 36 that has a top surface 38 and a bottom surface 40, and the bottom side 24 of the first portion 14 of the clamp 12 is coupled to the top surface 38. The primary portion 32 of the swivel 30 includes a second disk 41 that has an upper surface 42 and a lower surface 44. The upper surface 42 rotatably engages the bottom surface 40 of the first disk 36 such that the first disk 36 and the second disk 41 are independently rotatable with respect to each other. The first disk 36 has a plurality of apertures 43 each extending through said top surface 38 and the bottom surface 40. A pin 45 is extendable through a respective one of the apertures 43 to engage the second disk 41 for retaining the first disk 36 at a selected degree of rotation on the second disk 41. In this way the weed trimmer 20 can be oriented at a desired angle with respect to the swivel 30.

The secondary portion 34 of the swivel 30 comprises a first rod 46 that is coupled to and extends downwardly from the lower surface 44 of the second disk 41, and the first rod 46 has a distal end 48 with respect to the lower surface 44. The secondary portion 34 includes a ball 50 that is coupled to the distal end 48 of the first rod 46. The swivel 30 includes a cup 54 that contains the ball 50 such that the ball is rotatable in the cup 54. The cup 54 has a bottom end 56 and a top end 58, and the top end 56 is open for insertably receiving the ball 50. Additionally, the top end 56 has a diameter that is less than the diameter of the ball 50 to inhibit the ball 50 from being removable from the cup 54. A second rod 49 is coupled to and extends downwardly from the bottom end 56 of the cup and the second rod 49 has a distal end 51 with respect to the bottom end 56.

A pair of legs 60 is each coupled to and extends downwardly from the cup 54. Each of the legs 60 comprises a first half 62 that threadably engages a second half 64 such that each of the legs 60 has a telescopically adjustable length. An inside surface 66 of the first half 62 is threaded and an outside surface 68 of the second half 64 is threaded. In this way the outside surface 68 of the second half 64 threadably engages the inside surface 66 of the first half 62. Thus, the first half 62 can be rotated on the second half 64 for adjusting the length of the legs 60. Additionally, The first half 62 has a first end 70 and the second half 64 has a second end 72.

A coupling 74 is coupled to the distal end 51 of the second rod 49 associated with the secondary portion 34 of the swivel 30. The coupling 74 has a pair of receivers 76 that is each oriented at an angle with the distal end 51 of the second rod 49. Each of the receivers 76 receives the second end 72 of the second half 64 of a respective one of the legs 60 such that each of the legs 60 forms a Y-shape with the cup 54. A pair of shock absorbers 78 is provided and each of the shock absorbers 78 has a first end 80 and a second end 82. Each of the shock absorbers 78 is compressible along an axis extending through the first end 80 and the second end 82 of the shock absorbers 78. Moreover, the first end 80 of each of the shock absorbers 78 is coupled to the first end 70 of the first half 62 of a respective one of the legs 60. Each of the shock absorbers 78 may comprise a gas charged shock absorber, a spring loaded shock absorber or any other type of compressible shock absorber.

A pair of arms 84 is each coupled to a respective one of the legs 60. Each of the arms 84 has an elbow 86 thereon such that each of the arms 84 forms an angle with the respective leg 60. Each of the arms 84 has an upper end 88 and a lower end 90, and the elbow 86 is positioned between the upper end 88 and the lower end 90. The upper end 88 of each of the arms 84 is coupled to the second end 82 of a respective one of the shock absorbers 78. In this way a lower portion 92 of each of the arms 84 is oriented to extend along an axis is oriented parallel to a longitudinal axis of the cup 54 of the secondary portion 34 of the swivel 30.

A pair of rollers 94 is each rotatably coupled to a respective one of the arms 84 thereby facilitating each of the rollers 94 to roll along a support surface 96. In this way each of the rollers 94 can support the weed trimmer 20 to assist a physically limited user to employ the weed trimmer 20. Each of the rollers 94 is positioned on the lower portion 92 of the respective arm 84 at a point that is located adjacent to the lower end 90 of the respective arm 84. Each of the rollers 94 has a rotational axis that is oriented perpendicular to the lower portion 92 of the respective arm 84. Each of the rollers 94 may comprise a wheel, a rubber tire or other type of roller that can roll along a yard, a garden, a rock bed or any other location that a weed trimmer might be employed. Additionally, each of the rollers 94 is rotatable about a longitudinal axis of the lower portion 92 of the respective arm 84 such that the rollers 94 have 360.0 degrees of rotation on the respective arm 84.

In use, the clamp 12 is positioned around the pole 18 of the weed trimmer 20 at a selected location and the ball 50 is manipulated to position the legs 60 at a desired angle with respect to the pole 18 of the weed trimmer 20. In this way the rollers 94 support the weed trimmer 20 above the support surface 96 such that the user does not have to support the weight of the weed trimmer 20. The legs 60 can be adjusted to a desired height to place the weed trimmer 20 at the optimal height for the user. Additionally, the legs 60 facilitate a head 98 of the weed trimmer 20 to be positioned a desired distance from the support surface 96. In this way the weed trimmer 20 can be supported at a preferred orientation that facilitates the user to employ the weed trimmer 20 in the most efficient manner and with the least amount of effort.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weed trimmer trolley assembly for assisting a physically limited user with employing a weed trimmer, said assembly comprising:
a clamp having a first portion being closable with a second portion wherein said clamp is configured to be secured around a pole of a weed trimmer;
a swivel being rotatably disposed on said clamp, said swivel including a primary portion being rotatable about a first axis, said swivel including a secondary portion being rotatable about a perpendicular axis with respect to said first axis wherein said swivel is configured to be positionable at a variety of angles with respect to the weed trimmer;
a pair of legs, each of said legs being coupled to and extending downwardly from said swivel, each of said legs comprising a first half threadably engaging a second half such that each of said legs has an adjustable length;
a pair of arms, each of said arms being coupled to a respective one of said legs, each of said arms having an elbow thereon such that each of said arms forms an angle with said respective leg; and
a pair of rollers, each of said rollers being rotatably coupled to a respective one of said arms thereby facilitating each of said rollers to roll along a support surface wherein each of said rollers is configured to support the weed trimmer to assist a physically limited user to employ the weed trimmer.

2. The assembly according to claim 1, wherein each of said first portion and said second portion has a top side and a bottom side, said top side of said first portion being concavely arcuate with respect to said bottom side of said first portion, said bottom side of said second portion being concavely arcuate with respect to said top side of said second portion, said bottom side of said second portion being hingedly coupled to said top side of said first portion, said second portion being positionable in a closed position having said bottom side of said second portion resting on said top side of said first portion to define a hole wherein said hole is configured to have the pole of the weed trimmer extending therethrough.

3. The assembly according to claim 2, wherein said clamp includes a screw extending through said second portion and releasably engaging said first portion when said second portion is in said closed position, said screw tightening said second portion against said first portion when said screw is tightened wherein said screw is configured to compress said clamp around the pole of the weed trimmer.

4. The assembly according to claim 2, wherein said primary portion of said swivel comprises:
a first disk having a top surface and a bottom surface, said bottom side of said first portion of said clamp being coupled to said top surface; and
a second disk having an upper surface and a lower surface, said upper surface rotatably engaging said bottom surface of said first disk such that said first disk and said second disk are independently rotatable with respect to each other.

5. The assembly according to claim 4, wherein said secondary portion of said swivel comprises:
a first rod being coupled to and extending downwardly from said lower surface of said second disk, said first rod having a distal end with respect to said lower surface;
a ball being coupled to said distal end of said first rod; and
a cup having a top end and a bottom end, said top end being open, said top end receiving said ball such that said ball is rotatably positioned in said cup.

6. The assembly according to claim 5, wherein:
an inside surface of said first half is threaded;
an outside surface of said second half is threaded, said outside surface of said first half threadably engaging said inside surface of said second half thereby facilitating said first half to be rotated on said second half for adjusting the length of said legs;
said assembly includes a coupling being coupled to said bottom end of said cup of secondary portion of said swivel, said coupling having a pair of receivers each being oriented at an angle with said distal end of said cup, each of said receivers receiving said second end of said second half of a respective one of said legs such that each of said legs forms a Y-shape with said cup.

7. The assembly according to claim 1, further comprising a pair of shock absorbers, each of said shock absorbers having a first end and a second end, each of said shock absorbers being compressible along an axis extending through said first end and said second end of said shock absorbers, said first end of each of said shock absorbers being coupled to a first end of said first half of a respective one of said legs.

8. The assembly according to claim 7, wherein:
said secondary portion of said swivel includes a first rod and a cup; and
each of said arms has an upper end and a lower end, said elbow being positioned between said upper end and said lower end, said upper end of each of said arms being coupled to said second end of a respective one of said shock absorbers such that a lower portion of each of said arms is oriented to extend along an axis being oriented parallel to a longitudinal axis of said cup of said secondary portion of said swivel.

9. The assembly according to claim 8, wherein each of said rollers is positioned on said lower portion of said respective arm at a point being located adjacent to said lower end of said respective arm, each of said rollers having a rotational axis being oriented perpendicular to said lower portion of said respective arm.

10. A weed trimmer trolley assembly for assisting a physically limited user with employing a weed trimmer, said assembly comprising:
a clamp having a first portion being closable with a second portion wherein said clamp is configured to be secured around a pole of a weed trimmer, each of said first portion and said second portion having a top side and a bottom side, said top side of said first portion being concavely arcuate with respect to said bottom side of said first portion, said bottom side of said second portion being concavely arcuate with respect to said top side of said second portion, said bottom side of said second portion being hingedly coupled to said top side of said first portion, said second portion being positionable in a closed position having said bottom side of said second portion resting on said top side of said first portion to define a hole wherein said hole is configured to have the pole of the weed trimmer extending therethrough, said clamp including a screw extending through said second portion and releasably engaging said first portion when said second portion is in said closed position, said screw tightening said second portion against said first portion when said screw is tightened wherein said screw is configured to compress said clamp around the pole of the weed trimmer;
a swivel being rotatably disposed on said clamp, said swivel including a primary portion being rotatable about a first axis, said swivel including a secondary portion being ballable about a perpendicular axis with respect to said first axis wherein said swivel is configured to be positionable at a variety of angles with respect to the weed trimmer, said primary portion of said swivel comprising;
a first disk having a top surface and a bottom surface, said bottom side of said first portion of said clamp being coupled to said top surface; and
a second disk having an upper surface and a lower surface, said upper surface rotatably engaging said bottom surface of said first disk such that said first disk and said second disk are independently rotatable with respect to each other;
said secondary portion of said swivel comprising:
a first rod being coupled to and extending downwardly from said lower surface of said second disk, said first rod having a distal end with respect to said lower surface;
a ball being coupled to said distal end of said first rod; and
a cup having a top end and a bottom end, said top end being open, said top end receiving said ball such that said ball is rotatably positioned in said cup;
a pair of legs, each of said legs being coupled to and extending downwardly from said swivel, each of said legs comprising a first half threadably engaging a second half such that each of said legs has an adjustable length, an inside surface of said first half being threaded, an outside surface of said second half being threaded, said outside surface of said first half threadably engaging said inside surface of said second half thereby facilitating said first half to be rotated on said second half for adjusting the length of said legs;
a coupling being coupled to said bottom end of said cup of secondary portion of said swivel, said coupling having a pair of receivers each being oriented at an angle with said distal end of said cup, each of said receivers receiving said second end of said second half of a respective one of said legs such that each of said legs forms a Y-shape with said cup;
a pair of shock absorbers, each of said shock absorbers having a first end and a second end, each of said shock absorbers being compressible along an axis extending through said first end and said second end of said shock absorbers, said first end of each of said shock absorbers being coupled to said first end of said first half of a respective one of said legs;
a pair of arms, each of said arms being coupled to a respective one of said legs, each of said arms having an elbow thereon such that each of said arms forms an angle with said respective leg, each of said arms having an upper end and a lower end, said elbow being positioned between said upper end and said lower end, said upper end of each of said arms being coupled to said second end of a respective one of said shock absorbers such that a lower portion of each of said arms is oriented to extend along an axis being oriented parallel to a longitudinal axis of said cup of said secondary portion of said swivel; and
a pair of rollers, each of said rollers being rotatably coupled to a respective one of said arms thereby facilitating each of said rollers to roll along a support surface wherein each of said rollers is configured to support the weed trimmer to assist a physically limited user to employ the weed trimmer, each of said rollers being positioned on said lower portion of said respective arm at a point being located adjacent to said lower end of said respective arm, each of said rollers having a rotational axis being oriented perpendicular to said lower portion of said respective arm.

11. A weed trimmer trolley system for assisting a physically limited user with employing a weed trimmer, said system comprising:
a weed trimmer having a pole;
a clamp having a first portion being closable with a second portion for securing around said pole of said weed trimmer, each of said first portion and said second portion having a top side and a bottom side, said top side of said first portion being concavely arcuate with respect to said bottom side of said first portion, said bottom side of said second portion being concavely arcuate with respect to said top side of said second portion, said bottom side of said second portion being hingedly coupled to said top side of said first portion, said second portion being positionable in a closed position having said bottom side of said second portion resting on said top side of said first portion to define a hole having said pole of said weed trimmer extending therethrough, said clamp including a screw extending through said second portion and releasably engaging said first portion when said second portion is in said closed position, said screw tightening said second portion against said first portion when said screw is tightened to compress said clamp around said pole of said weed trimmer;
a swivel being rotatably disposed on said clamp, said swivel including a primary portion being rotatable about a first axis, said swivel including a secondary portion being ballable about a perpendicular axis with respect to said first axis to position said swivel at a variety of angles with respect to said weed trimmer, said primary portion of said swivel comprising;
a first disk having a top surface and a bottom surface, said bottom side of said first portion of said clamp being coupled to said top surface; and
a second disk having an upper surface and a lower surface, said upper surface rotatably engaging said bottom surface of said first disk such that said first disk and said second disk are independently rotatable with respect to each other;
said secondary portion of said swivel comprising:
a first rod being coupled to and extending downwardly from said lower surface of said second disk, said first rod having a distal end with respect to said lower surface;
a ball being coupled to said distal end of said first rod; and
a cup having a top end and a bottom end, said top end being open, said top end receiving said ball such that said ball is rotatably positioned in said cup;
a pair of legs, each of said legs being coupled to and extending downwardly from said ball, each of said legs comprising a first half threadably engaging a second half such that each of said legs has an adjustable length, an inside surface of said first half being threaded, an outside surface of said second half being threaded, said outside surface of said first half threadably engaging said inside surface of said second half thereby facilitating said first half to be rotated on said second half for adjusting the length of said legs;
a coupling being coupled to said bottom end of said cup of secondary portion of said swivel, said coupling having a pair of receivers each being oriented at an angle with said distal end of said cup, each of said receivers receiving said second end of said second half of a respective one of said legs such that each of said legs forms a Y-shape with said cup;
a pair of shock absorbers, each of said shock absorbers having a first end and a second end, each of said shock absorbers being compressible along an axis extending through said first end and said second end of said shock absorbers, said first end of each of said shock absorbers being coupled to said first end of said first half of a respective one of said legs;
a pair of arms, each of said arms being coupled to a respective one of said legs, each of said arms having an elbow thereon such that each of said arms forms an angle with said respective leg, each of said arms having an upper end and a lower end, said elbow being positioned between said upper end and said lower end, said upper end of each of said arms being coupled to said second end of a respective one of said shock absorbers such that a lower portion of each of said arms is oriented to extend along an axis being oriented parallel to a longitudinal axis of said cup of said secondary portion of said swivel; and
a pair of rollers, each of said rollers being rotatably coupled to a respective one of said arms thereby facilitating each of said rollers to roll along a support surface wherein each of said rollers is configured to support said weed trimmer to assist a physically limited user to employ said weed trimmer, each of said rollers being positioned on said lower portion of said respective arm at a point being located adjacent to said lower end of said respective arm, each of said rollers having a rotational axis being oriented perpendicular to said lower portion of said respective arm.
